(19) United States
(12) Patent Application Publication
(10) Pub. No.: US 2024/0342967 A1
(43) Pub. Date: Oct. 17, 2024

(54) INJECTION MOULDABLE COMPOSITION

(71) Applicant: Stichting Wageningen Research, Wageningen (NL)

(72) Inventors: Geraldus Gerardus Johannes Schennink, Wehl (NL); Wouter Post, Utrecht (NL); Fresia Maria Alvarado Chacon, Utrecht (NL)

(21) Appl. No.: 18/027,172

(22) PCT Filed: Sep. 23, 2021
(86) PCT No.: PCT/EP2021/076183

§ 371 Date: Mar. 20, 2023

(30) Foreign Application Priority Data
Sep. 23, 2020 (NL) 2026519

(51) Int. Cl. B29C 45/00; B29K 31/00; B29K 67/00

(52) U.S. Cl. CPC B29C 45/0001; B29K 2031/04; B29K 2067/046

(57) ABSTRACT

An injection mouldable composition includes polyester, polyvinyl acetate and lubricant, to a method of injection moulding the composition, and to an injection moulded article including the composition. The composition includes 30-94 wt % polyester; 5-45 wt % polyvinyl acetate; 1-10 wt % lubricant, and optionally up to 64 wt % additives, the total of polyester, polyvinyl acetate, lubricant and additives adding up to 100 wt %. The polyester has a MFR when measured according to ISO 1133 (210° C. and 2.16 kg) of more than 20 g/10 min.

### CROSS-REFERENCE TO RELATED APPLICATIONS

This application is the National Stage of International Application No. PCT/EP2021/076183, filed Sep. 23, 2021, which claims the benefit of Netherlands Application No. 2026519, filed Sep. 23, 2020, the contents of which is incorporated by reference herein.

### FIELD OF THE INVENTION

The present invention relates to a composition comprising polyester, polyvinyl acetate and lubricant, to a method of injection moulding the composition, and to an injection moulded article comprising the composition.

### BACKGROUND OF THE INVENTION

Foods such as salad, butter, tomatoes, etc. are usually packaged in plastic containers which have a very thin wall. These containers are preferably produced via injection moulding. The containers are low in weight, so that material cost savings can be made, and cycle times can be as short as possible. Although food producers are interested in biobased plastic packaging, injection moulded thin walled food containers of such biobased material compositions are not available on the market on a large scale. This is due to the fact that injection moulding of such thin walled containers is accompanied by additional challenges as compared to injection moulding of regular containers as a result of the thin wall. For example, compared to conventional injection moulding, thin wall moulding requires moulding machines that are designed and built to withstand higher stresses and injection pressures. The range of process parameters, which are employed for thin wall moulded parts, is considerably narrower than that of conventional injection moulding because thin parts are difficult for the injection unit of the machine to fill compared to thicker parts. Even with optimally designed parts and moulds, it is still more difficult to produce parts with thin walls.

The definition of a thin wall is related to the size of a part compared to its wall thickness. As the wall thickness reduces it gets harder to manufacture the part using the injection moulding process. For packaging containers a thin wall generally means a wall thickness that is less than 0.8 mm with a maximum flow path to wall thickness ratio larger than 200.

The flow length of a material is defined as the length of a mould that is filled before the injection moulded material solidifies under defined filling conditions. For a mould to be completely filled, the flow length of a material should at least equal the maximum flow path of the mould. There is an exponential dependency between the wall thickness and the flow properties, meaning that it becomes increasingly difficult to fill a mould when the wall thickness is reduced.

In industry, the melt flow index (MFR) is often used to define the flow properties of polymers. For example, the MFR of the biobased polymer polylactic acid (PLA) at processing temperatures may be tuned to be comparable to that of e.g. polypropylene. Yet polypropylene (PP) with an MFR of 30 g/10 min (measured according to ISO 1133 at 2.16 kg and 230° C. (i.e. the usual processing temperature for PP)) is very well useable for thin wall injection moulding, whereas for PLA with a comparable MFR this does not work. With respect to injection moulding, and especially thin wall injection moulding, the use of MFR to determine material flow properties gives a distorted image. The shear rates used for measuring the MFR are much lower than those used during injection moulding. At the high shear rates used for injection moulding, PP shows a considerable degree of shear thinning, and thus a reduced viscosity. PLA on the other hand behaves somewhat more like a Newtonian fluid and is still very viscous at high shear rates.

Spiral flow is therefore a more realistic measure for comparing the suitability of materials for thin wall injection moulding. Spiral flow is determined on an injection moulding machine by performing a specifically defined process using a spiral flow test mould. Important parameters of the process to be defined are cylinder temperature & mould temperature, maximum injection pressure & injection speed. The spiral flow test used to characterize the compositions of the present application is defined in more detail in the experimental section.

### SUMMARY OF THE INVENTION

It is an objective of the present invention to provide a polyester based composition with improved spiral flow properties. It is a further objective of the invention to provide a polyester based composition suitable for producing partially or completely biobased injection moulded thin walled plastic packaging. It is a further objective of the invention to provide a polyester based composition suitable for producing partially or completely biodegradable injection moulded thin walled plastic packaging. It is another objective of the present invention to provide a polyester based composition suitable for producing a transparent thin walled container by injection moulding.

Thereto, the present invention provides a composition comprising:
30-94 wt % polyester;
5-45 wt % polyvinyl acetate
1-10 wt % lubricant;
optionally up to 64 wt % additives;
the total of polyester, polyvinyl acetate, lubricant and additives adding up to 100 wt %;
   wherein the polyester has a MFR when measured according to ISO 1133 (210° C. and 2.16 kg) of more than 20 g/10 min, preferably more than 22 g/10 min, more preferably more than 24 g/10 min, most preferably more than 25 g/10 min.

It has been found by the inventors that such compositions have exceptional spiral flow properties, while also having a high E-modulus, strain at break and adequate impact resistance, with the possibility of being transparent.

The invention further provides a method for creating an injection moulded article, comprising the steps of:
a) blending a composition according to the invention,
b) extruding the blend,
c) injection moulding the extruded blend into an article.

The invention also provides an injection moulded article comprising the composition according to the invention.

### DETAILED DESCRIPTION OF THE INVENTION

All percentages are weight/weight percentages unless otherwise indicated. Unless specified otherwise, numerical ranges expressed in the format “from x to y” are understood to include x and y. When for a specific feature multiple preferred ranges are described in the format “from x to y”, it is understood that all ranges combining the different endpoints are also contemplated.

The composition comprises a polyester. The polyester may be a mixture of polyesters and/or it may be a copolyester. Polyesters commonly are the polycondensation products of dicarboxylic acids with dihydroxy alcohols (diols). Alternatively they may be formed by condensation of a hydroxy carboxylic acid, or by ring opening polymerisation of cyclic monomers such as lactones and lactides.

Preferably, the polyester has a weight average molecular weight (Mw) ranging between 30,000 and 1,000,000 g/mol, more preferably between 30,000 and 750,000 g/mol, even more preferably between 30,000 and 500,000 g/mol, even more preferably between 40,000 and 250,000 g/mol, and most preferably between 50,000 and 200,000 g/mol. The method of measuring the molecular weight is given in the experimental section.

Preferably, the polyester is a thermoplastic polyester. Furthermore, the polyester may be aromatic or aliphatic. Aromatic polyesters comprise aromatic groups, whereas aliphatic polyesters do not. Examples of aromatic polyesters include polyethylene terephthalate (PET), polybutylene terephthalate (PBT), polytrimethylene terephthalate (PTT), polyethylene furanoate (PEF), and polyethylene naphthalate (PEN). Aliphatic polyesters include poly (glycolic acid) (PGA), polylactic acid (PLA), polycaprolactone (PCL), polyhydroxyalkanoate (PHA), such as polyhydroxybutyrate (PHB) and poly (3-hydroxybutyrate-co-3-hydroxyvalerate) (PHBV), polyethylene adipate (PEA), and polybutylene succinate (PBS). Copolyesters such as polybutylene adipate terephthalate (PBAT) are based on aromatic as well as aliphatic monomers. As such copolyesters comprise aromatic groups, they are deemed to fall under the category of aromatic polyesters. In a preferred embodiment, the polyester is an aliphatic polyester.

Alternatively, polyesters may be categorized by their origin, being either biobased, i.e. made from renewable resources, or fossil based (non-renewable). Renewable resources can include corn, potatoes, rice, soy, sugarcane, wheat, and vegetable oil. Biobased plastics are made by creating plastic polymers from these raw materials, through either chemical or biological processes. Preferably, the polyester is either at least partially biobased, or more preferably fully biobased, as this reduces the impact on the environment. Examples of polyesters that may be at present be fully biobased are polylactic acid (PLA)—which may be derived from carbohydrates—, polyhydroxyalkanoates (PHAs) such as polyhydroxybutyrate (PHB)—which may be derived through microbial synthesis—, and polyethylene furanoate (PEF)—which may be produced from furandicarboxylic acid derived from plant-based sugars—. Today, Polybutylene succinate (PBS) is not 100% biobased. Still, it is expected that, in the near future, all raw materials for PBS will be produced via fermentation, so that a completely biobased PBS will be available. An example of a partially biobased polyester is plant bottle PET.

Furthermore, besides biobased, the polyester may be biodegradable. Preferably, the polyester is biodegradable, as this reduces the environmental impact of discarded articles comprising the composition of the invention. Biodegradable plastic degrades through exposure to naturally occurring microorganisms. When classifying a plastic as a biodegradable, the environment and timeframe must be specified; otherwise the claim is rendered pointless due to an array of variations. One specific form of biodegradation is compostability. Compostability is commonly determined according to European Standard EN 13432. Examples of compostable polyesters include PLA, PHB, PBAT, PCL, and PBS.

Preferably, the polyester is chosen from the group consisting of PLA, PGA, PBS, PBAT, PHA, PCL, and copolymers and/or mixtures thereof. Thus, preferably the polyester may be PLA, PGA, PBS, PBAT, PHA, or PCL; it may be a copolymer of two or more of PLA, PGA, PBS, PBAT, PHA, or PCL; and it may be a mixture of polymers, i.e. a mixture of the beforementioned homopolymers, of copolymers, or of homo-and copolymers.

Preferably the polyester is biobased and biodegradable, more preferably the polyester is chosen from the group consisting of PLA, PHA, PBS, and copolymers and/or mixtures thereof.

Most preferably, the polyester is PLA. PLA is biobased as well as biodegradable, and is a cost-efficient alternative to petroleum based plastics such as polypropylene (PP), polyethylene (PE), and polystyrene (PS). When used in the composition according to the invention, exceptional results are achieved as shown in the examples.

The terms polylactic acid, polylactide, and PLA may be used interchangeably and refer to polylactic acid polymers containing repeat units derived from lactic acid. Examples of suitable PLA grades are NatureWorks® Ingeo PLA polymer Ingeo 3251 D, 3001 D, 3100HP or 3260HP. Total Corbion PLA Luminy L105, L130, LX 530 or LX930 and Futerro® PLA.

PLA can be prepared by ring-opening polymerization of lactide, which is a cyclic dimer of lactic acid. Lactide includes L-lactide, which is a cyclic dimer of L-lactic acid, D-lactide, which is a cyclic dimer of D-lactic acid, meso-lactide, which is a cyclic dimer of D-lactic acid and L-lactic acid, and DL-lactide, which is a racemate of D-lactide and L-lactide.

The PLA polymers used in the invention can be derived from D-lactic acid, L-lactic acid, or a mixture thereof. Also a mixture of two or more PLA polymers can be used. The PLA for use in the invention may comprise the product of polymerization reaction of a mixture of L-lactides and D-lactides, also known as poly-DL-lactide (PDLLA). The PLA for use in the present blend may comprise the product of polymerization reaction of mainly D-lactides, also known as poly-D-lactide (PDLA). Preferably, The PLA comprises the product of polymerization reaction of mainly L-lactides (or L, L-lactides), also known as poly-L-lactide (PLLA). Other suitable PLA can be copolymers of PLLA with some D lactic acid units. PLLA-PDLA stereocomplexes can also be used. The polylactic acid for use may be amorphous PLA, crystalline PLA, or a blend of crystalline and amorphous PLA. A suitable amorphous PLA is for example Luminy LX 930. A suitable semi crystalline PLA is for example Nature Works Ingeo PLA 3251D.

The polylactic acid may exhibit a crystalline melt temperature (Tc) of from at least 135° C., for example of at least 140° C., for example of at least 145° C., for example of at least 150° C., for example of at least 160° C., as determined in accordance with ASTM D3418. In an embodiment, the polylactic acid may exhibit a crystalline melt temperature of at most 220° C., for example of at most 215° C., for example of at most 210° C., for example of at most 205° C., for example of at most 200° C. as determined in accordance with ASTM D3418. In an embodiment, the polylactic acid may exhibit a crystalline melt temperature of from 135° C. to 220° C., for example from 140° C. to 215° C., for example from 145° C. to 210° C., for example from 150° C. to 205° C., for example from 160° C. to 200° C., as determined in accordance with ASTM D3418.

In an embodiment, the polylactic acid may exhibit a glass transition temperature of at least 40° C., preferably more than 40° C., for example of at least 45° C., for example of at least 50° C., as determined in accordance with ASTM D3418. In an embodiment, the polylactic acid may exhibit a glass transition temperature of at most 85° C., for example of at most 80° C., for example of at most 70° C., for example of at most 60° C., as determined in accordance with ASTM D3418. In an embodiment, the polylactic acid may exhibit a glass transition temperature of from 40° C. to about 85° C., preferably from more than 40° C. to about 85° C., for example from 45° C. to 80° C., for example from 45° C. to 70° C., for example from 50° C. to 60° C., as determined in accordance with ASTM D3418.

In some embodiments, the polylactic acid can have a weight average molecular weight (Mw) ranging between 30,000 and 300,000 g/mol, more preferably between 40,000 and 250,000 g/mol, and even more preferably between 50,000 and 200,000 g/mol. The method of measuring the molecular weight is given in the experimental section.

In the composition according to the invention, the polyester has a MFR when measured according to ISO 1133 (210° C. and 2.16 kg) of more than 20 g/10 min, preferably more than 22 g/10 min, more preferably more than 24 g/10 min, even more preferably more than 25 g/10 min.

In a particularly preferred embodiment, the polyester has a MFR of more than 26 g/10 min, preferably more than 28 g/10 min, more preferably more than 30 g/10 min, most preferably more than 32 g/10 min when measured according to ISO 1133 (210° C. and 2.16 kg). The higher the MFR of the polyester, the better the spiral flow that can be achieved with the composition of the present invention. However the MFR of the polyester preferably does not exceed 250 g/10 min because although such a high MFR may lead to better spiral flow of the composition, the mechanical properties, such as modulus, yield strength and maximum elongation, deteriorate to such an extent that the composition is not useable in a plastic food container.

It is well-known that commonly, different types of polymers are not capable of forming a homogeneous mixture. Most polymers phase separate, thereby forming microsized droplets of the minority phase polymer in the matrix polymer, which results in an opaque blend. Many polyesters, such as PLA, are however miscible with polyvinyl acetate on a (nearly) molecular level. This is advantageous, as the mechanical properties of such a miscible blend are commonly completely different from the mechanical properties of an immiscible blend. Moreover, blends that are mixed on a molecular level may be transparent, depending on the properties of the individual polymers and the processing conditions. Although transparency is not a prerequisite, it is advantageous for producing plastic food containers, as the contents of transparent containers can easily be evaluated. Preferably, the composition is transparent.

The polyvinyl acetate, i.e. a polymer comprising vinyl acetate monomeric units, can be a either a homopolymer, it can be a copolymer, and/or a mixture. Suitable copolymers include ethylene-vinyl acetate copolymer (EVA), and copolymers of vinyl acetate with a further acid vinyl ester, such as vinyl acetate-vinyl laurate copolymers. Preferably, the polyvinyl acetate is a copolymer of vinyl acetate with a further acid vinyl ester. More preferably, the polyvinyl acetate is a copolymer of vinyl acetate and vinyl laurate.

Polyvinyl acetate may be synthesized from renewable resources, i.e. it may be biobased, which is preferred. Especially when the other components of the composition are also biobased, a completely biobased composition may be achieved. Furthermore, polyvinyl acetate is biodegradable, which makes polyvinyl acetate a suitable component of a biodegradable article such as a container.

Polyvinyl acetate (i.e. the homopolymer as well as its copolymers) can be produced as so called water-redispersible polymer powders. Polymer powders redispersible in water denote polymer compositions, obtained by drying of respective aqueous dispersions of base polymers in the presence of water-soluble drying aids, such as protective colloids like polyvinyl alcohol. Due to this process the fine resin particles of the base polymer are enclosed or encased by the water-soluble drying aid. The drying aids provide a shell around the resin particles and prevent the polymer powder from blocking or sticking together. Upon redispersion of the polymer powder in water the drying aids are dissolved in water and the base polymer is released in the form of primary particles redispersed in water (Schulze J. in TIZ, No. 9, 1985). Aqueous polymer dispersions are obtainable by polymerization of unsaturated monomers in water in the presence of protective colloids and/or emulsifiers or upon redispersion of polymer powders in water. This means polymer powders are different from mere solid resins, for instance. Due to the polymerization method applied, water redispersible polymer powders typically have a very high molecular weight, and accompanying low MFR. The weight average molecular weight of the polyvinyl acetate in water redispersible powders is typically higher than 1,000,000 g/mol.

Preferably, the polyvinyl acetate is not in the form of a water redispersible polymer powder, because the high molecular weight of such a powder does not result in a composition with good spiral flow properties. Thus, the weight average molecular weight (Mw) of the polyvinyl acetate is preferably lower than 1,000,000 g/mol. The polyvinyl acetate more preferably has a weight average molecular weight (Mw) ranging between 5,000 and 500,000 g/mol, even more preferably between 7,500 and 250,000 g/mol, and most preferably between 10,000 and 150,000 g/mol, when measured according to the method disclosed in the examples.

It has now surprisingly been found that the further combination of a polyester and polyvinyl acetate according to the invention with a lubricant results in compositions with an exceptional spiral flow, while also having a high E-modulus, strain at break and adequate impact resistance, with the possibility of forming a transparent injection moulded thin walled container, depending on the chosen materials and processing conditions. For example, it is known by the person skilled in the art that the transparency of a semicrystalline polymer may depend on the cooling rate of the polymer. Slow cooling rates will generally result in a higher overall degree of crystallinity, but more opaqueness due to the size of the formed crystallites.

The lubricant according to the invention is preferably an oil or oil derivative (i.e. chemically modified oil). The lubricant may comprise a fatty acid or a fatty acid ester. A fatty acid is a carboxylic acid with a long aliphatic chain, which is either saturated, i.e. comprising no carbon-carbon double bonds, or unsaturated, i.e. comprising at least one carbon-carbon double bond. A fatty acid ester is based on one or more fatty acids. Fatty acids differ by length, often categorized as short to very long. Short-chain fatty acids (SCFA) are fatty acids with aliphatic tails of five or fewer carbons (e.g. butyric acid). Medium-chain fatty acids (MCFA) are fatty acids with aliphatic tails of 6 to 12 carbons. Long-chain fatty acids (LCFA) are fatty acids with aliphatic tails of 13 to 21 carbons. Very long chain fatty acids (VLCFA) are fatty acids with aliphatic tails of 22 or more carbons. Preferably the fatty acid or fatty acid ester is or is based on an MCFA (e.g. lauric acid) or LCFA (e.g. stearic acid). More preferably, the fatty acid or fatty acid ester has an aliphatic tail of 10-20 carbons. At longer aliphatic tails the flow improves, yet the compatibility with PLA decreases. Even more preferably the fatty acid or fatty acid ester has an aliphatic tail of 12-18 carbons. This provides the optimum between flow properties and PLA compatibility. Fatty acid esters are e.g. triglycerides, phospholipids, cholesteryl esters, etc. Fatty acid esters are for example comprised in oils, such as vegetable oils.

Vegetable oils are suitable lubricants. Examples of vegetable oils are e.g. maize oil, sunflower oil, soybean oil, etc.

The unsaturated fatty acids or fatty acid esters may be chemically modified, preferably epoxidized. Examples of suitable lubricants comprising an epoxidized fatty acid ester are epoxidized soybean oil (ESO) and epoxidized linseed oil (ELO). Epoxidized soybean oil is the most preferred lubricant.

The composition may comprise additives. Suitable additives are colorants, stabilizers, crosslinking agents, fillers, mould release agents, clarifying agents, biodegradability enhancers, non-polyester type polymers, etc. A particularly preferred non-polyester type polymer is thermoplastic starch (TPS). TPS is renewable, readily biodegradable, easily modified both physically and chemically, and available in bulk at low cost, making it a very attractive raw material for manufacture of “green” plastics.

The composition according to the invention preferably has a glass transition temperature Tg of at least 35° C. preferably at least 40° C., preferably at least 45° C., more preferably at least 50° C. Especially in case an amorphous polyester is used, the Tg should lie above room temperature, and preferably higher, such as above body temperature in order for an article made from the composition to retain its shape upon use.

Preferably, the composition is completely biobased and biodegradable.

The compositions according to the invention may have an E-modulus when measured according to ISO 527-1 of at least 0.8 GPa, and are therefore suitable as an alternative to PP. Moreover, the compositions may even have an E-modulus of at least 1.0 GPa, such as at least 1.5 GPa.

The compositions according to the invention may have a MFR when measured according to ISO 1133 at 190° C. and 2.16 kg of more than 100 g/10 min, such as more than 110 g/10 min, and even more than 120 g/10 min.

In a preferred embodiment, the composition according to the invention comprises
35-88 wt % polyester;
11-45 wt % polyvinyl acetate;
1-10 wt % lubricant;
optionally up to 53 wt % additives.

In a further preferred embodiment, the composition according to the invention comprises
40-80 wt % polyester;
15-45 wt % polyvinyl acetate;
1-10 wt % lubricant;
optionally up to 44 wt % additives.

The invention further provides for a method for producing an injection moulded article, comprising the steps of:
a) blending a composition according to the invention,
b) injection moulding the extruded blend into an article.

Blending of the composition can be carried out according to any physical blending method and combinations thereof known in the art. This can be, for instance, dry blending, wet blending or melt blending. The blending conditions depend upon the blending technique and components involved. Depending on the method, the components (i.e. polyester, polyvinyl acetate, lubricant and optionally additives) can be in any appropriate form, for example, fluff, powder, granulate, pellet, solution, slurry, and/or emulsion.

If dry blending of the polymer is employed, the dry blending conditions may include temperatures from room temperature up to just under the melting temperature of the components. The components can be dry blended prior to a melt blending stage, which can take place for example in an extruder.

Melt processing is fast and simple and makes use of standard equipment of the thermoplastics industry. The components can be melt blended in a batch process such as in a mixer, or in a continuous process, such as in an extruder e.g. a single or twin screw extruder. During melt blending, the temperature at which the components are combined will generally be in the range between the highest melting point of the components employed and up to about 80° C. above such melting point, preferably between such melting point and up to 30° C. above it. The time required for the melt blending can vary broadly and depends on the method of blending employed. The time required is the time sufficient to thoroughly mix the components. Generally, the individual components are blended for a time of 10 seconds up to 10 minutes, preferably up to 5 minutes, more preferably up to 2 minutes.

The components can also be wet blended whereby at least one of the components is in solution or slurry form. If solution blending methods are employed, the blending temperature will generally be 25° C. to 50° C. above the cloud point of the solution involved. The solvent or diluent is then removed by evaporation to leave behind a homogeneous blend of the components.

For injection moulding, any injection moulding machine known in the art may be used in the present invention, such as for example Sumitomo DEMAG IntElect2 75/420-250. All mould types may be used.

The injection moulding cycle may be split into three stages: the filling phase, the holding phase, and the cooling phase. During the filling phase, polymer melt is forced into an empty (cold) cavity; once the cavity is filled; extra material is packed inside the cavity and held under high pressure in order to compensate for density increase during cooling. The cooling phase starts when the cavity gate is sealed by polymer solidification; further temperature decrease and polymer crystallisation takes place during the cooling stage. Typical temperatures for the filling step are of from 160 to 280° C., preferably of from 180 to 260° C.

Injection-moulding as used herein is performed using methods and equipment well known to the person skilled in the art. An overview of injection moulding and compression moulding is for example given in Injection Moulding Handbook, D. V. Rosato et al., 3^{rd} edition, 2000, Kluwer Academic Publishers.

The invention also provides an injection moulded article comprising the composition according to the invention. Preferably, the article is a container. The moulds used in the production of the article may be any mould usually used in the production of such containers.

The shape of the container of the present application is not especially limited. The term container may include open top containers, containers that are configured to receive a lid or cap, cylindrical containers, rectangular containers, etc.

The container of the present application may be used in various packaging applications, such as for example food packaging, detergent packaging, cosmetic packaging, paint packaging or medical packaging. The container of the present application is particularly useful for food packaging. In a preferred embodiment, the container of the invention is a food container.

Preferably, the container has a wall thickness of less than 0.8 mm, such as between 0.5 and 0.8 mm, and a maximum flow path to wall thickness ratio of more than 200.

Preferably, the container is transparent.

### EXAMPLES

### Test Methods

The E-modulus (in MPa), stress at break (in MPa) and strain at break (in %) were determined using a Zwick Z010 all-round line 10 kN mechanical testing machine according to ISO 527-1.

The impact (notched and unnotched, in kJ/m²) were determined by ISO 179/1eU & ISO 1791/eA respectively using a Ceast impact tester.

MFR was determined according to ISO1133 at 190° C. and 2.16 kg, unless otherwise specified.

Molecular weight has been determined with help of a Viscotek HP-SEC system with a VE-2001 GPCmax high pressure pump with autosampler and a TDA305 Triple Detector Array. The effluent was 1,1,1,3,3,3-hexafluor-2-propanol (HFIP)+0.02M KTFA.

A sample to be measured was dissolved overnight in 3 mL effluent in 4 ml HPLC vials at a concentration of 4-6 mg/ml of sample. Before measuring, filtering was performed through 0.45 μm PTFE syringe filters. Other settings used were:
·Flow: 0.7 ml/min.
·Oven temperature: 30° C.
Injection volume: (standard) 100 μL.

The UV signal was not used from the Diode Array Detector. Narrow standard PolyCAL PMMA 60 kD (from Viscotek) was used for absolute calibration of the system (Mw=59,575 g/mol, DPI=1.054, Wt=21.92 mg/10 ml eluent). For determining absolute MWD's of the polymer, the concentrations of the samples were calculated from the peak area of the RI signal. For PEF a dn/dc of 0.242 ml/g was used, for PET dn/dc=0.2562 ml/g and for PNF dn/dc=0.2331 ml/g.

### Materials

NW 3251D—Nature Works: biobased PLA, transparent, with a MFR of 69.3 g/10 min (ISO 1133, 210° C., 2.16 kg), crystalline melt temperature of 155-170° C. (ASTM D3418), and glass transition temperature of 55-60° C. (ASTM D3418).

PPR 10232—Total Polymers: random copolymer polypropylene, with a MFR of 40 g/10 min (ISO 1133, 230°° C., 2,16 kg), and melting point of 147° C. (ISO 3146).

Lankroflex E2307 (ESO)—Valtris: epoxidized soybean oil.

Fatty acids ‘lauric acid’ (C12), was supplied by Croda.

Vinnex 8880 (Vinnex)—Wacker: vinyl acetate-vinyl laurate copolymer with a Tg of 21° C., and MFR of >50 g/10 min (100° C., 2.16 kg).

Vinnapas B1.5—Wacker: vinyl acetate homopolymer with a Tg of 33° C., and Molecular weight (Mw) of 15000 g/mol when measured with SEC, based on PS standards.

SUKANO® PLA mr S533: PLA mould release masterbatch as delivered by Sukano, Switzerland.

### Example 1: Spiral Flow & Mechanical Properties

### Processing Tests: Compounding

A PLA based batch with high flow properties was produced based on NW3251D as carrier material and Vinnex 8880 and Lankroflex E2307 as additives.

NW3251D and Vinnex 8880 were dried for 16 hours at 80° C. and 30° C. respectively in a dryer prior to compounding. After drying each component, a mixture of 57 parts by weight of NW3251D, 38 parts by weight of Vinnex 8880 and 5 parts by weight of Lankroflex E2307 was extruded on a Berstorff ZE 25 CL*40 D twin screw extruder into a homogeneous strand with a temperature profile (from hopper to die) of 20/140/185/188/188/188/188/180/180/175/175° C. and 300 rpm. After cooling the strand using a water bath, the strand was pelletized into cylindrical shaped pellets. After extrusion, the cylindrically shaped pellets were dried for 16 hours at 80° C. in a dryer.

### Processing Tests: Injection Moulding

The spiral flow was determined with help of a Sumitomo DEMAG IntElect2 75/420-250 injection moulding machine equipped with a 18 mm screw and spiral flow mould (with hot runner) with a maximum length of 120 cm (square surface is 5 by 2 mm). In case of PLA based compositions the main process parameters during the process were:
Cylinder temperature from hopper to nose: 35/170/190/190/190° C.
Hot runner temperature: 195° C.
Mould temperature: 30° C.
Maximum injection pressure: 700 bar
Maximum injection speed: 15.3 cm³/s

Maximum injection time: 5 s
No holding time/pressure
Cooling time: 15 sec

First, about 10 samples were produced and discarded. Then 10 product samples were collected and analysed on their flow length. Spiral flow length of the composition was determined as average of these 10 separate values.

Injection moulding of tensile and impact bars was performed with a Sumitomo DEMAG IntElect2 75/420-250 machine equipped with an appropriate mould for test samples.

Results for various compositions are summarized in Table 1 below.

TABLE 1

| | Young's | Ultimate | Strain | Impact | Impact | | Spiral | |
|---|---|---|---|---|---|---|---|---|
| | Modulus | strength | at break | unnotched | notched | MFR | Flow | |
| Compound | (MPa) | (MPa) | (%) | (kj/m2) | (kj/m2) | (g/10 min) | (cm) | Tg |
| PP (Total | 1267 | 34.7 | 824.1 | DNB | 5.2 | 28.7 | >100* | n.a. |
| PPR 10232) | [23] | [0.3] | [11.7] | | [0.1] | [0.8]* | | |
| PLA-1 | 3545 | 67.2 | 3.3 | 16.9 | 1.7 | 34.0 | 37.2 | 64 |
| (NW3251D) | [31] | [0.5] | [0.8] | [0.7] | [0.4] | [1.0] | [0.2] | |
| PLA-1 + 40 | 2858 | 52.9 | 6.7 | 13.1 | 0.6 | 166 | 89.4 | 56 |
| wt. % Vinnex | [17] | [0.7] | [2.6] | [2] | [0] | [5.0] | [0.6] | |
| PLA-1 + 5% | 3272 | 54.9 | 69.3 | 28.8 | 2.9 | 45.0 | 43.2 | 60 |
| ESO | [16] | [0.4] | [13.3] | [6.3] | [0.1] | [3.0] | [0.2] | |
| PLA-1 + 5% | 3338 | 51.6 | 1.9 | 18.9 | 1.8 | 82.8 | N.A. | 54 |
| C12 | [24] | [0.5] | [0.1] | [1.2] | [0.6] | [2.0] | | |
| PLA-1 + 38 | 2636 | 38.4 | 188.4 | 30.3 | 2.7 | 250 | 118.8 | 50 |
| wt. % Vinnex + | [18] | [0.8] | [21.9] | [16.8] | [0.1] | [11.0] | [0.9] | |
| 5 wt. % ESO | | | | | | | | |

*measured at 230° C.
standard deviation is given between brackets [ ]

As can be seen from Table 1 pure (biobased) PLA has a relatively high Young's modulus (E-modulus) of 3545 MPa, and high ultimate strength (stress at break) of 67.2 MPa as compared to PP. However, strain at break (maximal elongation) is low, and the material behaves like a brittle material, which is undesirable for use in e.g. food containers. Such containers are preferably somewhat deformable. The spiral flow is only 37 cm.

Addition of only 5% lubricant increases the spiral flow to 43 cm. However, this value is not yet suitable for filling the mould of a typical thin walled container.

Addition of only 40% polyvinyl acetate is able to bring the spiral flow up to 89 cm, which would be a suitable value for injection moulding thin walled containers, while retaining a high E-modulus and stress at break. However, elongation and impact strength are unsatisfactory.

Addition of both polyvinyl acetate and a lubricant to the polyester provides a synergistic effect. As is the case for the compositions with only lubricant or only polyvinyl acetate, a composition comprising a combination of both additives (i.e. both PVAc and lubricant) also displays a good E-modulus and stress at break. Surprisingly however, both the spiral flow as well as the maximum elongation outperform those for compositions which do not comprise the combination of lubricant and polyvinyl acetate. The spiral flow and maximum elongation values are higher than what could be expected based on a mere juxtaposition.

### Example 2: Containers

### Processing Tests: Compounding

A PLA based batch with high flow properties was produced based on NW3251D as carrier material and Vinnex 8880 and Lankroflex E2307 as additives.

NW3251D and Vinnex 8880 were dried for 16 hours at 80° C. and 30° C. respectively in a dryer prior to compounding. After drying each component, a mixture of 78.5 parts by weight of NW3251D, 15 parts by weight of Vinnex 8880 and 6.5 parts by weight of Lankroflex E2307 was extruded on a Berstorff ZE 25 CL*40 D twin screw extruder into a homogeneous strand with a temperature profile (from hopper to die) of 20/140/185/188/188/188/188/180/180/175/175° C. and 300 rpm. After cooling the strand using a water bath, the strand was pelletized into cylindrical shaped pellets. After extrusion, the cylindrically shaped pellets were dried for 16 hours at 80° C. in a dryer.

### Processing Tests: Injection Moulding

A single container (rectangular as sketched in FIG. 1) mould was mounted on a Sumitomo DEMAG IntElect2 75/420-250 injection moulding machine equipped with a 18 mm screw. Average wall thickness of the product was 0.5 mm; maximum flow path was 100 mm, thus the flow path to wall thickness ratio was 200. In case of PLA based compositions the main process parameters during this specific process were:
Cylinder temperature from hopper to nose: 30/165/195/195/195° C.
Hot runner temperature: 205° C.
Mould temperature: 40° C.
Maximum injection pressure: 1750 bar (and lower)
Maximum injection speed: 36.6 cm³/s
Maximum injection time: 5 s
Holding pressure: 600 bar for 3 s
Cooling time: 7 s

Various formulations were tested with this mould. With a dry blend composition consisting of 95 wt % PLA NW 3251D and 5 wt % MR S533 masterbatch the mould could not be filled properly with the settings as described above (see FIG. 5). However when the compounded composition consisted of 78.5 parts by weight NW3251D, 15 parts by weight Vinnex 8880 and 6.5 parts by weight Lankroflex E2307 and subsequently dry blended with 5 wt % MR S533 (thus 95 wt % compounded composition and 5 wt % MR S533), the mould could easily be filled. The maximum needed injection pressure could even be reduced to 1250 bar without causing problems (see FIG. 6).

### BRIEF DESCRIPTION OF THE FIGURES

FIG. 1 is a schematic picture of a rectangular thin walled plastic container.

FIG. 2 is a schematic picture of a cylindrical thin walled container.

FIG. 3 is a schematic picture of a cross-section of the container of FIG. 2.

FIG. 4 is a graph of spiral flow vs. MFI (MFR) for various compositions.

FIG. 5 is a photograph of the incomplete container resulting from injection moulding 95 wt % PLA NW 3251D and 5 wt % MR S533.

FIG. 6 is photograph of the complete container resulting from injection moulding a composition of 78.5 parts by weight NW3251D, 15 parts by weight Vinnex 8880 and 6.5 parts by weight Lankroflex E2307 and subsequently dry blended with 5 wt % MR S533.

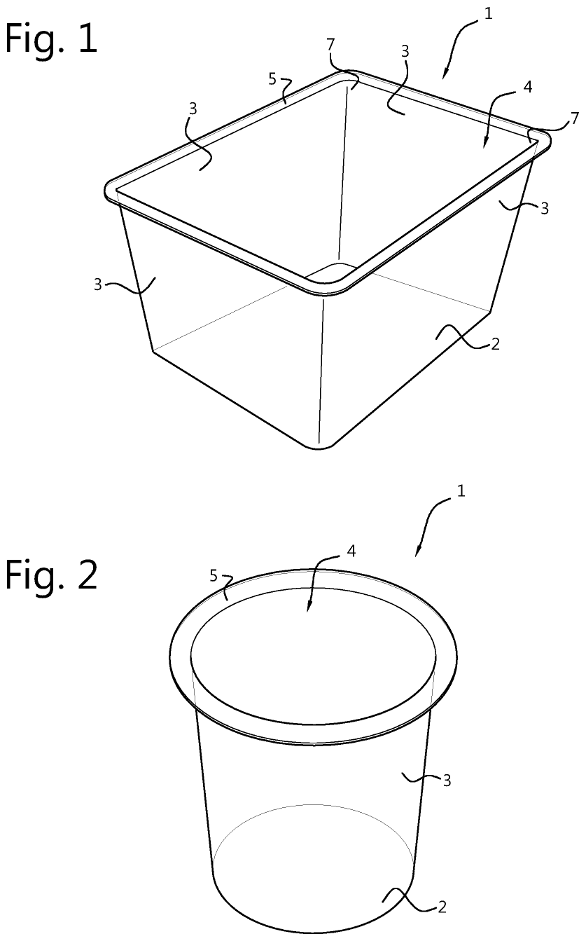

### DETAILED DESCRIPTION OF FIGS. 1-3

The plastic container 1 in FIG. 1 has a bottom 2, four side walls 3, and an open top 4. The side walls 3 have a thickness and extend from the edges of the bottom 2 to the open top 4. The side walls have an upper portion 5 which may have a thickness that is different from the thickness of the rest of the side walls, and the upper portion 5 may be configured to receive a lid. The bottom has a centre 6. The maximum flow path in this case is defined as the path from the centre of the bottom to outer flange corner 7, as defined by line 8.

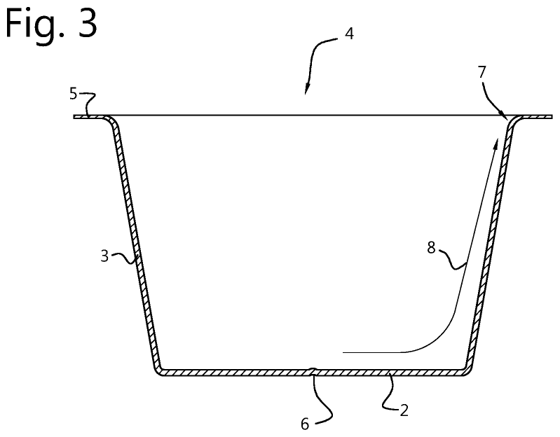

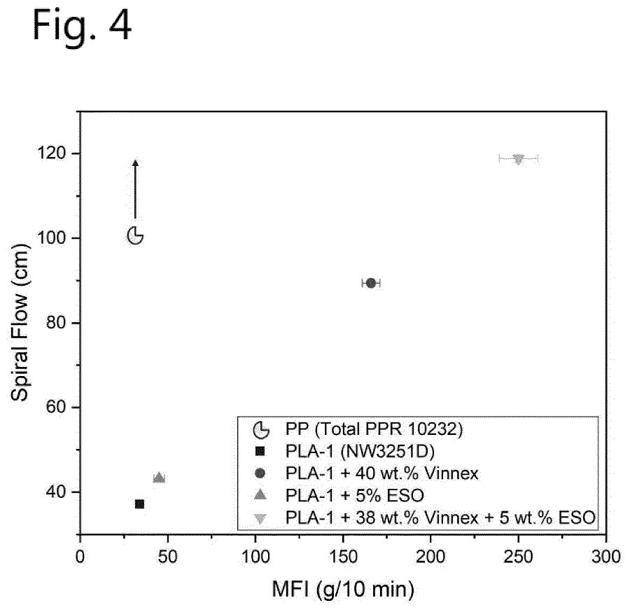

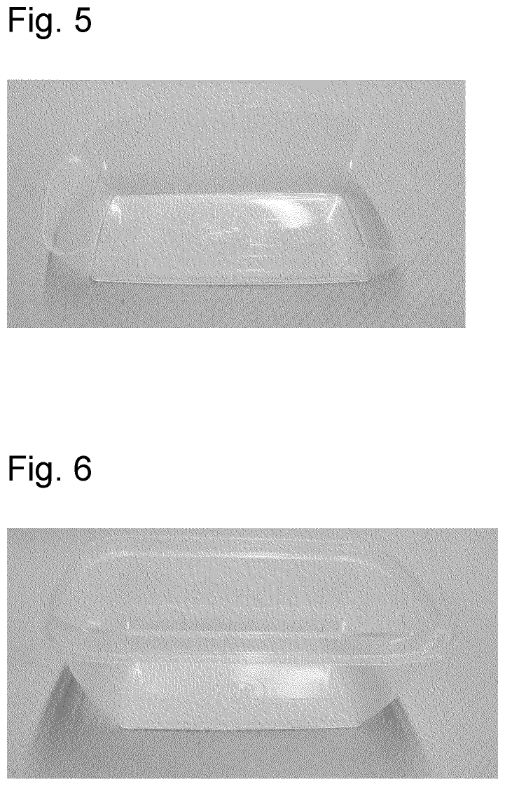

In an alternative embodiment, shown in FIG. 2 and FIG. 3, the plastic container 1 may have a circular circumference. In this case, the maximum flow path is defined by line 8 extending from centre 6 to outer circumference of upper portion 5, which has been drawn to be flange shaped.

1. An injection mouldable composition comprising:
30-94 wt % polyester;
5-45 wt % polyvinyl acetate;
1-10 wt % lubricant;
optionally up to 64 wt % additives;
wherein the total of polyester, polyvinyl acetate, lubricant and additives adding up to 100 wt %; and
wherein the polyester has a MFR when measured according to ISO 1133 (210° C. and 2.16 kg) of more than 20 g/10 min, preferably more than 22 g/10 min, more preferably more than 24 g/10 min, most preferably more than 25 g/10 min.

2. The composition according to claim 1, wherein the polyester has a MFR of more than 26 g/10 min, preferably more than 28 g/10 min, more preferably more than 30 g/10 min, most preferably more than 32 g/10 min when measured according to ISO 1133 (210° C. and 2.16 kg).

3. The composition according to claim 1, wherein the polyester is chosen from the group consisting of polylactic acid, polyglycolic acid, polybutylene succinate, polybutylene adipate terephthalate, polyhydroxyalkanoate, polycaprolactone, and copolymers and/or mixtures thereof.

4. The composition according to claim 1, wherein the polyester is biobased.

5. The composition according to claim 1, wherein the polyester is biodegradable.

6. The composition according to claim 1, wherein the polyester is polylactic acid.

7. The composition according to claim 1, wherein the polyvinyl acetate has a weight average molecular weight (Mw) ranging between 5,000 and 500,000 g/mol, preferably between 7,500 and 250,000 g/mol, and most preferably between 10,000 and 150,000 g/mol.

8. The composition according to claim 1, wherein the polyvinyl acetate is biobased.

9. The composition according to claim 1, wherein the polyvinyl acetate is a copolymer of vinyl acetate with a further acid vinyl ester.

10. The composition according to claim 1, wherein the polyvinyl acetate is a copolymer of vinyl acetate and vinyl laurate.

11. The composition according to claim 1 any one of the preceding claims, wherein the lubricant comprises a fatty acid or fatty acid ester.

12. The composition according to claim 1, wherein the lubricant is chosen from the group consisting of epoxidized soybean oil, epoxidized linseed oil, lauric acid, stearic acid and combinations thereof, preferably wherein the lubricant is epoxidized linseed oil.

13. The composition according to claim 1, wherein the composition has an E-modulus according to ISO 527-1 which is higher than 0.8 GPa, preferably higher than 1.0 GPa, more preferably higher than 1.5 GPa.

14. The composition according to claim 1, wherein the composition has a spiral flow of more than 90 cm, preferably more than 100 cm, most preferably more than 110 cm, as measured in a Sumitomo DEMAG IntElect2 75/420-250 injection moulding machine operating at the conditions described in the specification.

15. The composition according to claim 1, wherein the composition has a Tg of at least 40° C., preferably at least 45° C., most preferably at least 50° C. as determined in accordance with ASTM D3418.

16. A method for producing an injection moulded article, comprising the steps of:
a) blending a composition according to claim 1, and
b) injection moulding the blend into an article.

17. An injection moulded article comprising the composition according to claim 1.

18. The article according to claim 17, wherein the article is a container, preferably a food container.

19. The container according to claim 18 having a wall thickness of less than 0.8 mm, preferably of 0.5-0.8 mm, and a maximum flow path to wall thickness ratio of more than 200.

20. The article according to claim 17, wherein the article is transparent.
